(19) United States
(12) Patent Application Publication
(10) Pub. No.: US 2026/0028248 A1
(43) Pub. Date: Jan. 29, 2026

(54) WATER FILTER ASSEMBLY FOR A REFRIGERATOR APPLIANCE

(71) Applicant: Haier US Appliance Solutions, Inc., Wilmington, DE (US)

(72) Inventor: Thomas Earl McKeehan, JR., Crestwood, KY (US)

(21) Appl. No.: 18/783,957

(22) Filed: Jul. 25, 2024

(51) Int. Cl. C02F 1/00

(52) U.S. Cl. CPC C02F 1/003; C02F 2201/004; C02F 2307/12

(57) ABSTRACT

A water filtration assembly may include a filtration housing forming a first end distal from a second end. The second end may define a cap opening. The water filtration assembly may include an end cap. The end cap may define a wire passage therethrough. The end cap may be mated to the filtration housing at the cap opening. The end cap may include a circumferential fluid seal. The circumferential fluid seal may be attached to the end cap. The circumferential fluid seal may be positioned between the end cap and the cap opening to seal the filtration housing. The water filtration assembly may include an electrical connector that may extend through the wire passage to electrically connect the filtration housing to a power source separate from the water filtration assembly.

### FIELD OF THE DISCLOSURE

The present subject matter relates generally to a refrigerator appliance, and more particularly to a water filtration assembly for a refrigerator appliance.

### BACKGROUND OF THE DISCLOSURE

Water filtration assemblies, such as for refrigerator appliances, standalone kitchen vessels, or mainline water filtration, can filter water entering the water filtration assembly, such as to improve taste, appearance, or remove undesired particulates. Certain refrigerator appliances may include water filter assemblies for filtering water. Water filter assemblies can filter water entering the refrigerator appliances to provide filtered water to various refrigerator appliance components, such as an ice maker or a water dispenser.

Often, water filter assembly for appliances may include one or more features that require power, such as various lights, sensors, valves, actuators, filtration means, hardware, etc. Conventionally, the water is routed in and out of the filter assembly through a filter manifold, which is generally a permanent component of the refrigerator appliance. As such, the power is typically transferred or supplied to the internal electronic components of the water filter assemblies via integration of electrical connections into the manifold. However, power through the manifold can increase the risk of water exposure to the electronic components of the filter assembly. In addition, routing the power through the manifold can also increase the complexity of the design of the manifold, which may inhibit integration of systems and methods for operating a water filtration assembly that use or modulate voltage or current at the water filtration assembly.

Accordingly, a water filtration assembly for an appliance that obviates one or more of the above-mentioned drawbacks would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a refrigerator appliance is provided. The refrigerator appliance may include a cabinet. The cabinet may include a plurality of internal walls. The plurality of internal walls may define a chilled chamber. The refrigerator appliance may include a water filtration assembly mounted within the chilled chamber. The water filtration assembly may include a manifold. The water filtration assembly may include a filtration housing selectively mounted to at least one wall of the plurality of internal walls via the manifold. The filtration housing may form a first end distal from a second end. The second end may define a cap opening. The water filtration assembly may include an end cap that may define a wire passage therethrough. The end cap may be mated to the filtration housing at the cap opening. The end cap may include a circumferential fluid seal. The seal element may be attached to the end cap. The seal element may be positioned between the end cap and the cap opening to seal the filtration housing. The water filtration assembly may include an electrical connector that may extend through the wire passage to electrically couple the filtration housing to a power source separate from the water filtration assembly.

In another exemplary aspect of the present disclosure, a water filtration assembly is provided. The water filtration assembly may include a filtration housing forming a first end distal from a second end. The second end may define a cap opening. The water filtration assembly may include an end cap. The end cap may define a wire passage therethrough. The end cap may be mated to the filtration housing at the cap opening. The end cap may include a circumferential fluid seal. The circumferential fluid seal may be attached to the end cap. The circumferential fluid seal may be positioned between the end cap and the cap opening to seal the filtration housing. The water filtration assembly may include an electrical connector that may extend through the wire passage to electrically connect the filtration housing to a power source separate from the water filtration assembly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides an elevation view of a refrigerator appliance according to exemplary embodiments of the present disclosure.

FIG. 2 provides a perspective view of the exemplary refrigerator appliance of FIG. 1.

FIG. 3 provides an elevation view of the exemplary refrigerator appliance of FIG. 1, wherein the doors are shown in an open position.

FIG. 4 provides a simplified side elevation view of an embodiment of a water filtration assembly within a refrigerator appliance according to exemplary embodiments of the present disclosure.

FIG. 5 provides a perspective view of a water filtration assembly according to one or more exemplary embodiments of the present subject matter.

FIG. 6 provides a perspective view of a portion of a water filtration assembly according to one or more exemplary embodiments of the present subject matter.

FIG. 7 provides a perspective view of a water filtration assembly with a housing label thereof removed according to one or more exemplary embodiments of the present subject matter.

FIG. 8 provides an exploded view of a water filtration assembly according to one or more exemplary embodiments of the present subject matter.

FIG. 9 provides a perspective view of an end cap of a water filtration assembly according to one or more exemplary embodiments of the present subject matter.

FIG. 10 provides a cross-sectional view of the end cap of FIG. 11.

FIG. 11 provides a schematic side view of a water filter of an exemplary water filtration assembly in accordance with an embodiment of the present disclosure.

FIG. 12 provides a schematic plan view of a water filter of an exemplary water filtration assembly in accordance with an embodiment of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Embodiments of the present subject matter generally include a water filtration assembly, such as for a refrigerator appliance. As will be understood, the exemplary water filtration assembly may include features for guiding or routing electrical connectors (e.g., wires) through exterior walls of the water filtration assembly, for instance, to electrically connect or couple electrical components positioned within the water filtration assembly with a power supply. Particularly, the exemplary water filtration assembly advantageously includes an end cap that defines a wire passage for guiding or routing the electrical connectors into the water filtration assembly. Moreover, the end cap may advantageously include one or more circumferential fluid seals for sealing the electrical connectors (e.g., from water) within the water filtration assembly. For example, the end cap may advantageously include one or more O-ring seals, or an adhesive medium attached thereto that are configured to seal or prevent leaks of the water filtration assembly.

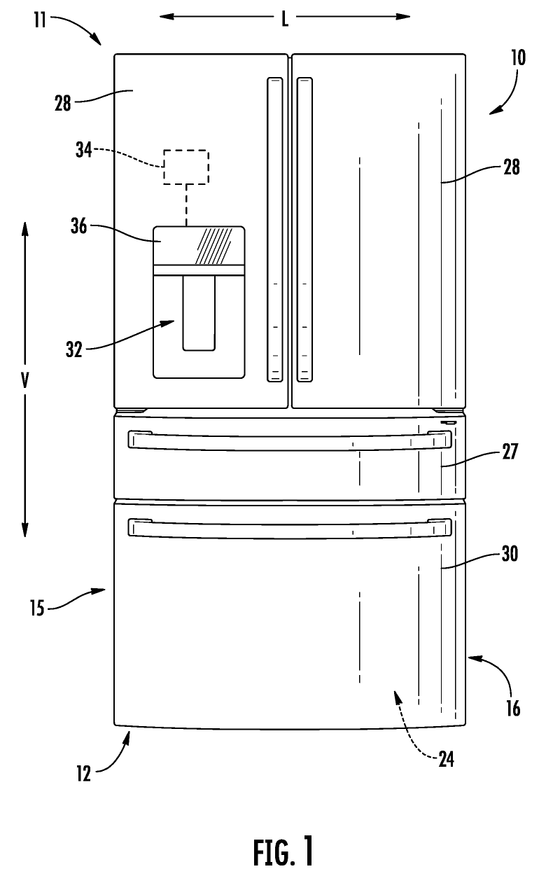

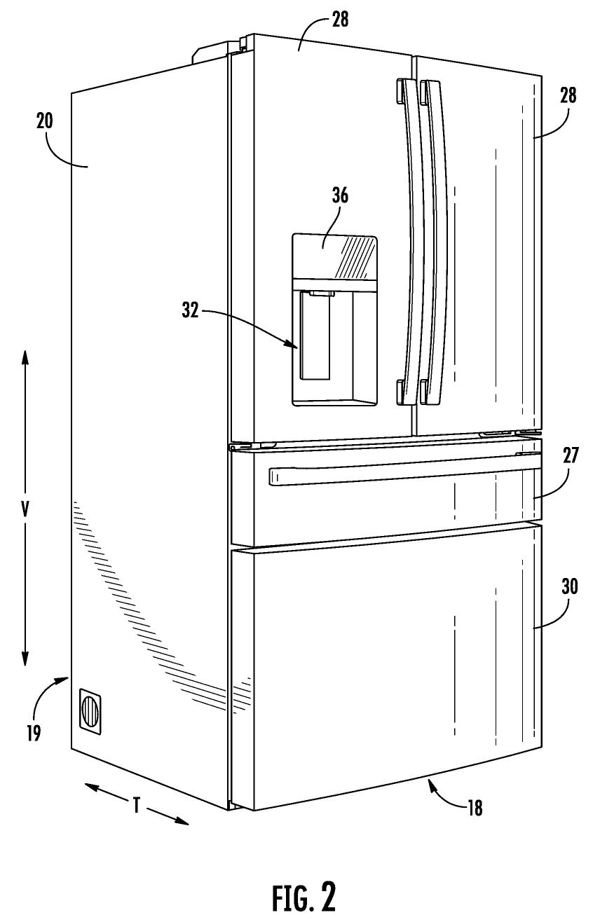

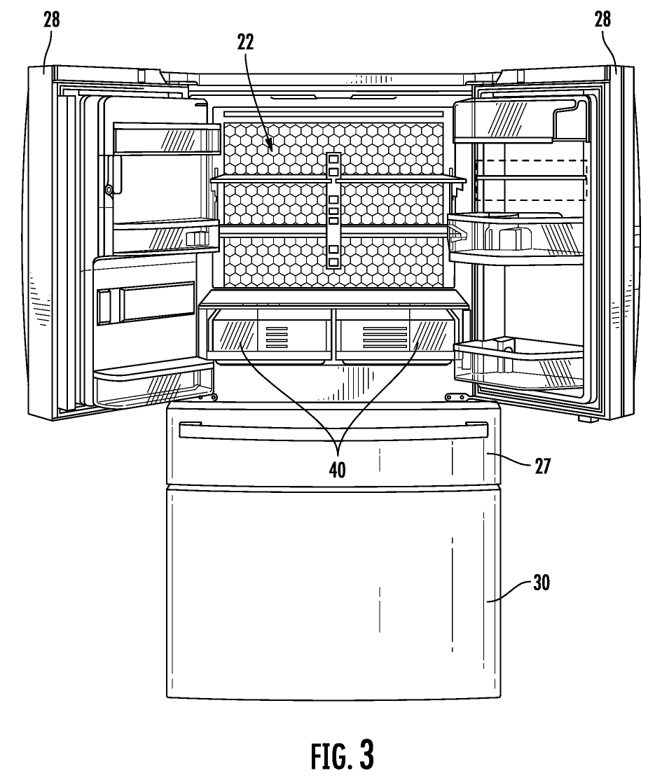

Referring now to the drawings, FIG. 1 illustrates a front view of an embodiment of a refrigerator appliance 10 according to the present disclosure. FIG. 2 illustrates a perspective view of the refrigerator appliance 10 of FIG. 1. FIG. 3 illustrates a front view of the refrigerator appliance 10 of FIG. 1 with refrigerator doors 28 in an open position. Referring particularly to FIG. 1, the refrigerator appliance 10 extends between a top 11 and a bottom 12 along a vertical direction V. The refrigerator appliance 10 also extends between a first side 15 and a second side 16 along a lateral direction L. As shown in FIG. 2, a transverse direction T may additionally be defined perpendicular to the vertical and lateral directions V, L. The refrigerator appliance 10 extends along the transverse direction T between a front portion 18 and a back portion 19.

The refrigerator appliance 10 may include a cabinet or housing 20 (FIG. 2) defining an upper fresh food chamber 22 (FIG. 3) and a lower freezer storage chamber 24 arranged below the upper fresh food chamber 22 along the vertical direction V. An auxiliary food storage chamber 25 may be positioned between the upper fresh food chamber 22 and the lower freezer storage chamber 24, e.g., along the vertical direction V. Because the lower freezer storage chamber 24 is positioned below the upper fresh food chamber 22, the refrigerator appliance 10 may be generally referred to as a bottom mount refrigerator. In the embodiment, the housing 20 may also define a mechanical compartment (not shown) for receipt of a sealed cooling system (not shown). Using the teachings disclosed herein, one of ordinary skill in the art will understand that the present technology can be used with other types of refrigerators (e.g., side-by-side) or a freezer appliance as well. Consequently, the description set forth herein is for illustrative purposes only and is not intended to limit the technology in any aspect.

Referring now particularly to FIG. 3, the refrigerator doors 28 may each be rotatably hinged to an edge of the housing 20 for accessing the upper fresh food chamber 22. It should be noted that while two refrigerator doors 28 in a “French door” configuration are illustrated, any suitable arrangement of doors utilizing one, two or more doors is within the scope and spirit of the present disclosure. A freezer door 30 may be arranged below the refrigerator doors 28 for accessing the lower freezer storage chamber 24. In the embodiment, the freezer door 30 is coupled to a freezer drawer (not shown) slidably mounted within the lower freezer storage chamber 24. An auxiliary door 27 may be coupled to an auxiliary drawer which may be slidably mounted within the auxiliary food storage chamber 25.

Referring back to FIG. 1, operation of the refrigerator appliance 10 can be regulated by a controller 34 that is operatively coupled to a user interface panel 36. The user interface panel 36 may provide selections for user manipulation of the operation of the refrigerator appliance 10 to modify environmental conditions therein, such as temperature selections, etc. In some embodiments, the user interface panel 36 is proximate a dispenser assembly 32. In response to user manipulation of the user interface panel 36, the controller 34 may operate various components of the refrigerator appliance 10. Operation of the refrigerator appliance 10 may be regulated by the controller 34, e.g., the controller 34 may regulate operation of various components of the refrigerator appliance 10 in response to programming and/or user manipulation of the user interface panel 36.

The controller 34 may include a memory and one or more microprocessors, CPUs or the like, such as general or special purpose microprocessors operable to execute programming instructions or micro-control code associated with operation of the refrigerator appliance 10. The memory may represent random access memory such as DRAM, or read only memory such as ROM or FLASH. In one embodiment, the processor executes programming instructions stored in memory. The memory may be a separate component from the processor or may be included onboard within the processor. It should be noted that controller(s) 34 as disclosed herein are capable of and may be operable to perform any methods and associated method steps as disclosed herein.

The controller 34 may be positioned in a variety of locations throughout the refrigerator appliance 10. In the illustrated embodiment, the controller 34 is located within the refrigerator doors 28. In such an embodiment, input/output (“I/O”) signals may be routed between the controller and various operational components of the refrigerator appliance 10. In one embodiment, the user interface panel 36 represents a general purpose I/O (“GPIO”) device or functional block. In one embodiment, the user interface panel 36 includes input components, such as one or more of a variety of electrical, mechanical or electro-mechanical input devices including rotary dials, push buttons, and touch pads. The user interface panel 36 may include a display component, such as a digital or analog display device designed to provide operational feedback to a user. For example, the user interface panel 36 may include a touchscreen providing both input and display functionality. The user interface panel 36 may be in communication with the controller 34 via one or more signal lines or shared communication busses.

Using the teachings disclosed herein, one of skill in the art will understand that the present disclosure can be used with other types of refrigerators such as a refrigerator/freezer combination, side-by-side, bottom mount, compact, and any other style or model of refrigerator appliance. Accordingly, other configurations of the refrigerator appliance 10 could be provided, it being understood that the configurations shown in the accompanying figures and the description set forth herein are by way of example for illustrative purposes only.

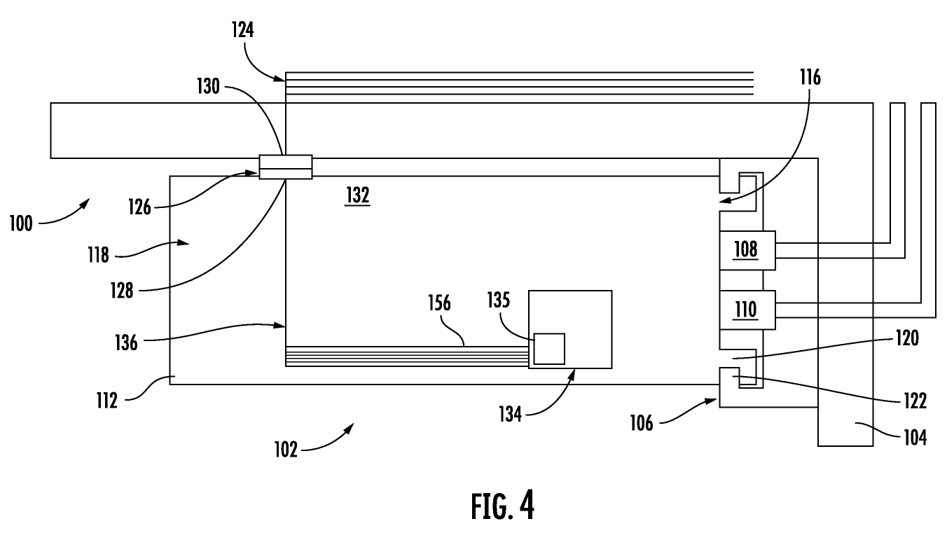

Referring now to FIG. 4, a simplified side view of an embodiment of an appliance wall 104 of an appliance 100 (such as an interior wall, an exterior wall, a side wall, etc.) having a water filtration assembly 102 secured thereto according to the present disclosure is illustrated. In particular, as shown, the water filtration assembly 102 has a filtration housing 112 and a water filtration medium (e.g., filter medium 138 described in more detail below) within the filtration housing 112. In addition, as shown, the filtration housing 112 may have a cylindrical configuration. In further embodiments, the filtration housing 112 may have any other suitable configuration other than a cylindrical configuration. Moreover, as shown, the water filtration assembly 102 may also include a liquid receiving space 132 within the filtration housing 112 and an electronics compartment 134 having one or more electronic components housed, at least in part, therein. In such embodiments, the electronics compartment 134 is fluidly isolated from the liquid receiving space 132, and thus fluidly isolated from the flow of water received within the liquid receiving space 132.

In further embodiments, as shown, the water filtration assembly 102 includes a manifold 106 that can be mounted to the appliance wall 104 of the appliance 100. Accordingly, as shown, the manifold 106 may generally contain a filter latching/mating interface and water connections therein. Furthermore, as shown, the appliance 100 generally includes a water source (not shown) that provides water to and from the water filtration assembly 102, e.g., through the manifold 106 via a water inlet 108 and a water outlet 110. Thus, in certain embodiments, the water filtration assembly 102 is in fluid communication with the water inlet 108 and the water outlet 110.

In further embodiments, the filtration housing 112 includes a first end 116 opposite a second end 118. As such, in an embodiment, the first end 116 is for securing the water filtration assembly 102 to the manifold via the filter latching/mating interface, with the manifold 106 being secured to the appliance wall 104 of the appliance 100. In particular embodiments, as shown in FIG. 4, the filter latching/mating interface may include the first end 116 of the filtration housing 112 having one or more interlocking features 120 and corresponding interlocking features 122 of the manifold 106. In such embodiments, the interlocking features 120 of the first end 116 of the filtration housing 112 are configured to engage with the corresponding interlocking features 122 of the manifold 106 for securing the filtration housing 112 to the appliance 100. In further embodiments, the first end 116 of the filtration housing 112 may be secured to the manifold 106 using any suitable means.

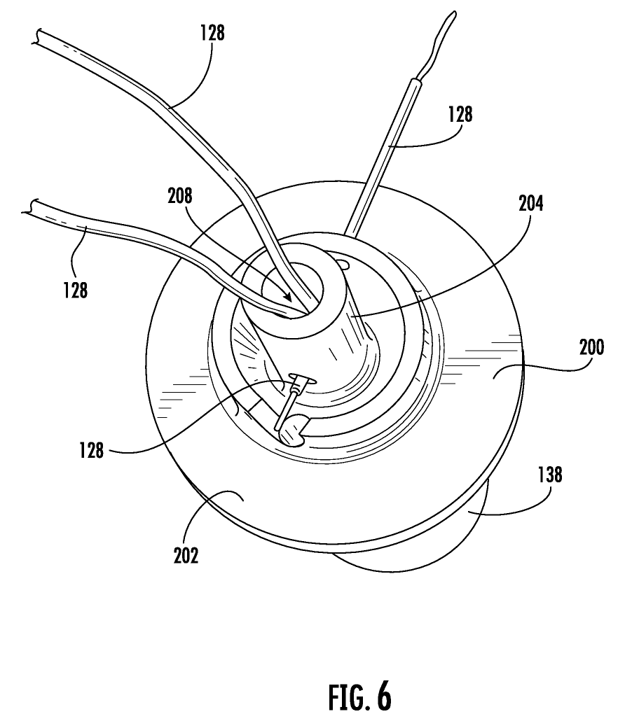

Referring still to FIG. 4, the water filtration assembly 102 further includes an electrical connection 126 electrically coupling the water filtration assembly 102 to a power source or a controller (e.g., controller 34 illustrated in FIG. 1 and described above). In certain embodiments, the power source may be any suitable source of electricity. As will be described in more detail below, the electrical connection 126 may include one or more electrical connectors 128 (e.g., electrical wires) that may be extended through an end cap 200 (e.g., FIG. 6) of the water filtration assembly 102. The electrical connectors may electrically couple the power source to the electronics compartment 134 having one or more electronic components housed within the filtration housing 112.

Furthermore, as shown, the electrical connection 126 may include one or more electrical harnesses 136, 124. Accordingly, the electrical connectors 128 may be electrically coupled between a first electrical harness 136 and a second electrical harness 124. The first electrical harness 136 may be electrically coupled to the electronics compartment 134 having one or more electronic components housed within the filtration housing 112. The second electrical harness 124 may be electrically coupled to the power source or any other communication device such as the controller 34. In this regard, the electrical connectors 128 may transmit electrical power from the power source to the electronics compartment 134.

Furthermore, as shown, the electrical connection 126 is separate and spaced apart from the manifold 106 and the flow of water received therein, e.g., separate and spaced apart from the water inlet port(s) 108 and the water outlet port(s) 110. As such, in an embodiment, when electrical connectors 128 electrically coupled the power source to the electronics compartment 134, power is provided to the water filtration assembly 102 from the power source, for example, via conduction through the electrical connectors 128. In addition to providing power or in the alternative, one or more other signals for communication or sensing may also be provided to the water filtration assembly 102 when the electrical connectors 128 electrically connects the power source to the electronics compartment 134.

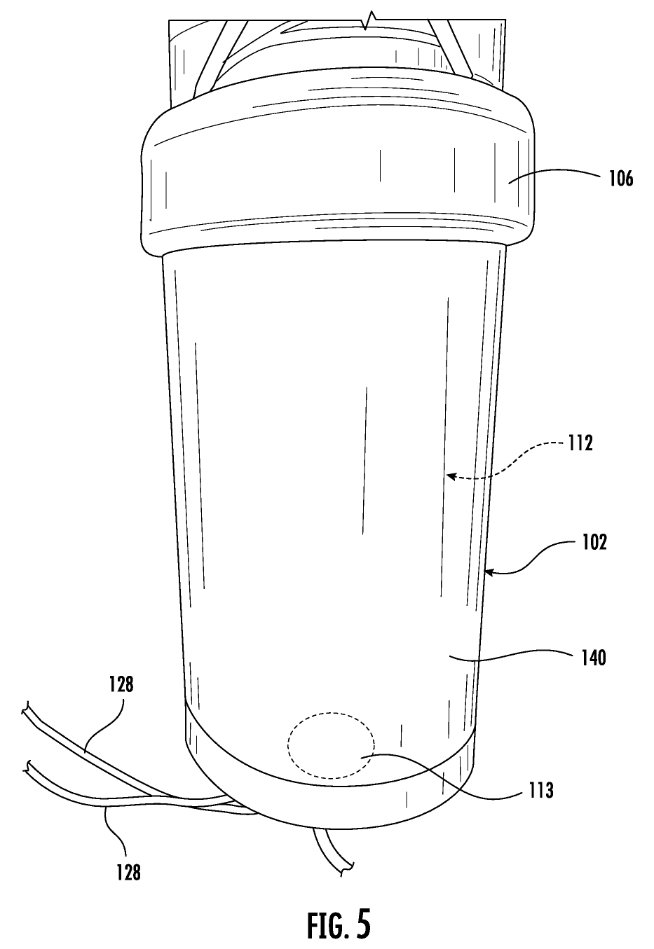

Turning now to FIG. 5, an embodiment of the water filtration assembly 102 is provided. Generally, as illustrated in FIG. 5, the water filtration assembly 102 may be attached to manifold 106 at the first end 116 thereof. In some embodiments, a housing label 140 may be disposed on the filtration housing 112. Generally, the housing label 140 is separate and spaced apart from the fluid inlet port 108 and the fluid outlet port 110. For instance, the housing label 140 may include an adhesive layer or coating (e.g., applied to an interior surface of the housing label 140) that adheres or sticks to an external surface of filtration housing 112. Additionally or alternatively, a separate exterior label or coating (e.g., fitted polymer, such as a shrink wrap or vacuum-sealed layer) may be provided to hold housing label 140 to filtration housing 112. Optionally, housing label 140 may extend about at least a portion of filtration housing 112. As would be understood, housing label 140 may include printed text, labeling, or figures indicative or descriptive of the water filtration assembly 102. Nonetheless, as would also be understood, the present disclosure is not limited to any particular printed text, labeling, or figures.

As will be appreciated in more detail below, the water filtration assembly 102 may include an electrochemical configuration to remove ions, particles, debris, or other particulates from water. In this regard, in various embodiments, the water filtration assembly 102 may include various electrical connectors 128 (e.g., wires) that are extended through the walls of the water filtration assembly 102 to provide power to electrical components disposed within the filtration housing 112 of the water filtration assembly 102. Moreover, embodiments of the present subject matter advantageously provide one or more circumferential fluid seals that seal the water filtration assembly to protect the electrical connectors 128 from being exposed to liquid (e.g., water) within the water filtration assembly 102.

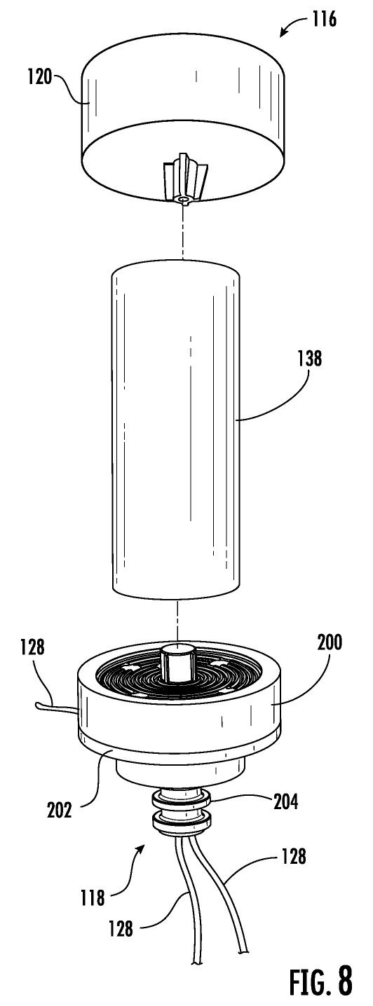

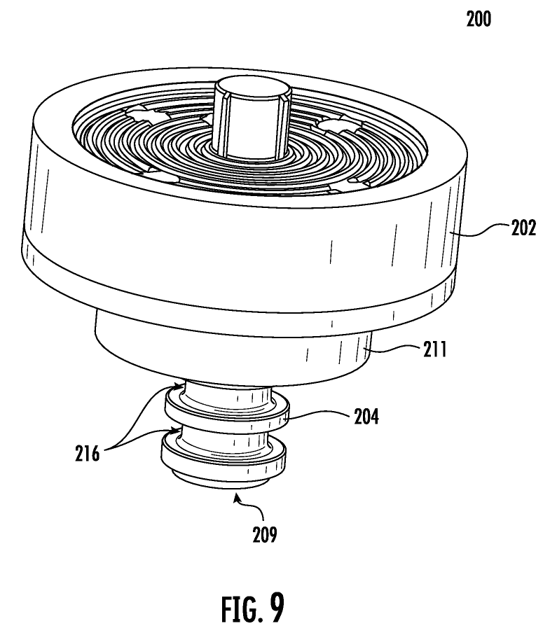

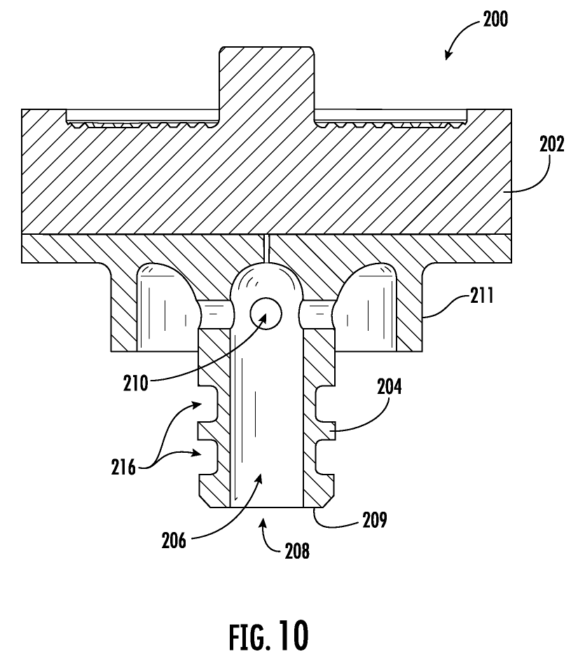

Referring now to FIGS. 6 through 11, embodiments of the water filtration assembly 102 are provided. In some embodiments, the water filtration assembly 102 includes the end cap 200 disposed at the second end 118 of the filtration housing 112. The end cap 200 may generally include a cylindrical body 202 and a neck 204. The neck 204 may be extended from the cylindrical body 202. In some embodiments, the neck 204 of the end cap 200 defines a wire passage 206 (e.g., FIG. 10) therethrough. The wire passage 206 may extend from a bottom opening 208 at a bottom surface 209 of the neck 204 and a side opening 210 disposed at a side surface 211 of the neck 204. Notably, the wire passage 206 may be configured to guide or route the electrical connectors 128 from outside of the water filtration assembly 102 to the interior of the water filtration assembly 102.

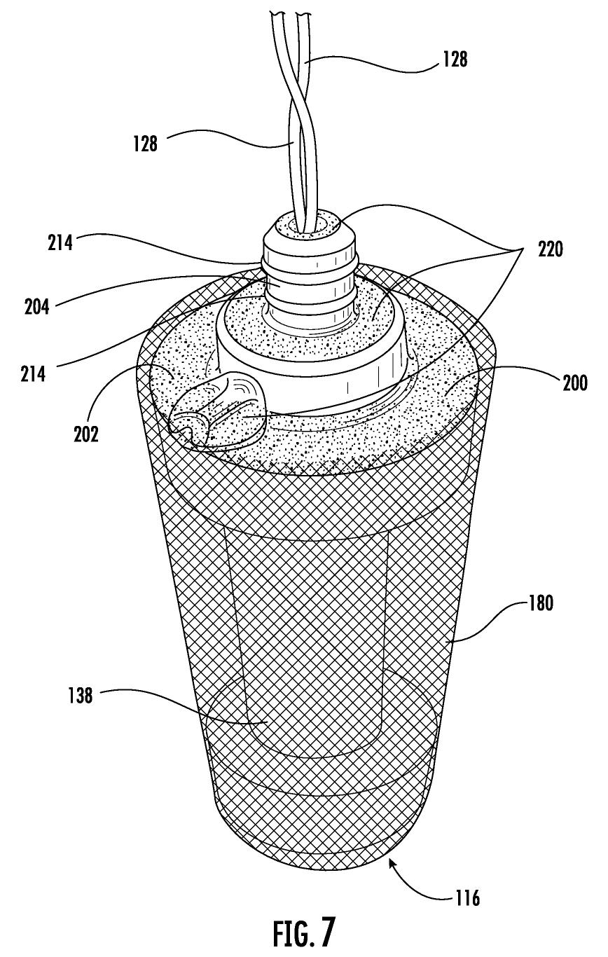

Moreover, the end cap 200 may include one or more circumferential fluid seals that advantageously prevent or mitigate the potential for a leakage (e.g., a water leakage) at the water filtration assembly 102. In some embodiments, the second end 118 of the filtration housing 112 defines a cap opening 113. In such embodiments, at least a portion of the end cap 200 may be mated to the filtration housing 112 at the cap opening 133. More particularly, the neck 204 of the end cap 200 may be mated to the filtration housing 112 at the cap opening 113. In some embodiments, one or more circumferential fluid seals 214 (e.g., FIG. 7) may be positioned within grooves 216 defined by the neck of the end cap 200 (e.g., to seal the filtration housing 112 at the cap opening 113). In such embodiments, the circumferential fluid seal 214 includes one or more O-ring seals received in the one or more grooves 216. When the end cap 200 is mated to the filtration housing 112 at the cap opening 113, the O-ring seals may be compressed between the neck 204 of the end cap 200 and the cap opening 113 to advantageously form a seal at the interface between the end cap 200 and the filtration housing 112.

Additionally or alternatively, the end cap 200 may include an adhesive fluid seal 220 separate from the circumferential fluid seal 214. For instance, the adhesive fluid seal 220 may be positioned within the wire passage 206 to seal the electrical connectors 128 (e.g., from exposure to water) within the wire passage 206. Particularly, in such embodiments, the adhesive fluid seal 220 includes an adhesive material, such as a polymer based adhesive material, that is disposed within the wire passage 206 (e.g., around the electrical connectors 128). The adhesive fluid seal 220 may seal the interior of the end cap 200 (e.g., the wire passage 206) such that water may not leak into the wire passage 206 and contact the electrical connectors 128 positioned within the wire passage 206.

Alternatively, in some other instances, the end cap 200 may be overmolded onto or around the electrical connectors 128. Particularly in such embodiment, the end cap 200 may be constructed by injection molding a polymer over or around the electrical connectors 128 (e.g., as would be understood). In such embodiments, the overmolded construction of the end cap 200 advantageously seals the electrical connectors within the end cap 200.

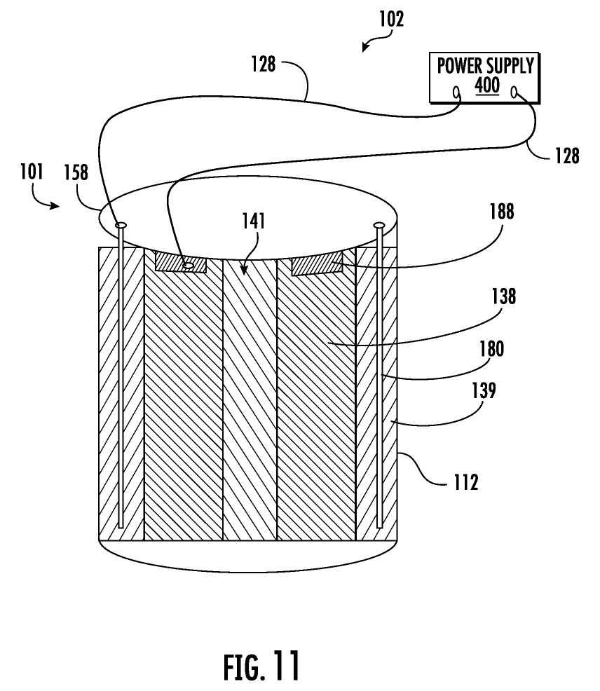

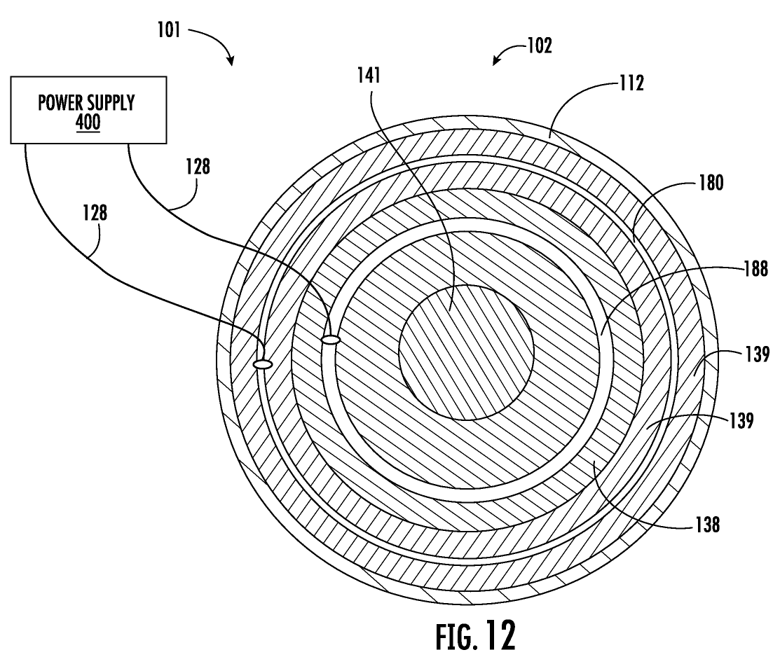

Referring to FIGS. 11 and 12, embodiments of the water filtration assembly 102 may include an electrochemical configuration to remove ions, particles, debris, or other particulates from water, such as depicted schematically at volume 139, and a filter medium 138. In various embodiments, the filter medium 138 includes a carbon block or substrate, such as an activated carbon medium. The water filtration assembly 102 is configured to apply a potential difference between a first electrode 188 at the filter medium 138 and a second electrode 180 at the water 139. A first electrode 188 is operably positioned or coupled to the filter medium 138. A second electrode 180 extends into a separate from the filter medium 138, such as a volume at which unfiltered water 139 is positioned within the filtration housing 112. The second electrode 180 forms a rod, a plate, or a wall extending into the volume. The electrodes 180, 188 form, at least in part, an electrolytic cell 101 configured as a cathode electrode and an anode electrode.

In some embodiments, a first volume forming is formed at the filtration housing 112. The first volume forms a plenum at which unfiltered water may be received, such as adjacent to a first side of the filter medium 138. A second volume forms a plenum at which water filtered through the filter medium 138 is provided, such as adjacent to a second side of the filter medium 138.

In various embodiments, a power supply or driving system 400, such as an electronic driving system, is configured to supply a controlled voltage or current output at the electrolytic cell. For instance, the power supply is electrically coupled to the electrodes 180, 188, such as depicted via connectors 128. In some embodiments, connectors 128 may form electrical wires. In some embodiments, the power supply or driving system 400 is configured to selectively apply voltage or current at the electrolytic cell based on a period of time. The period of time may include one or more frequencies of application and inverse polarity of applying voltage or current at the electrolytic cell to reverse a flow of ionic current in the electrolytic cell. Reversing the flow of ionic current may form a gap between a surface of the filter medium 138 and a sediment layer formed from filtration of water through the filter medium 138 (e.g., formed from unfiltered water 139 passing through the filter medium 138 to a volume at which filtered water is positioned, such as depicted at 141. Forming the gap may remove obstructions at the filter medium 138 that may restore permeability of the filter medium 138, such as to improve the flow characteristic or maintain the flow characteristic at a desired level. Restoring permeability of the filter medium 138 may facilitate increased life and useability of the filter medium and improve flowrate or pressure drop across the filter medium.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance comprising:
a cabinet comprising a plurality of internal walls, the plurality of internal walls defining a chilled chamber; and
a water filtration assembly mounted within the chilled chamber, the water filtration assembly comprising:
a manifold,
a filtration housing selectively mounted to at least one wall of the plurality of internal walls via the manifold, the filtration housing forming a first end distal from a second end, the second end defining a cap opening,
an end cap defining a wire passage therethrough, the end cap being mated to the filtration housing at the cap opening, the end cap comprising a circumferential fluid seal, the circumferential fluid seal being attached to the end cap, the circumferential fluid seal being positioned between the end cap and the cap opening to seal the filtration housing, and
an electrical connector extending through the wire passage to electrically couple the filtration housing to a power source separate from the water filtration assembly.

2. The refrigerator appliance of claim 1, wherein the end cap comprises a cylindrical body and a neck extended from the cylindrical body, wherein the circumferential fluid seal comprises one or more O-ring seals, and wherein the neck comprises one or more slots for receiving the one or more O-ring seals.

3. The refrigerator appliance of claim 1, wherein the circumferential fluid seal is positioned around the end cap, wherein the end cap further comprises an adhesive fluid seal, wherein the adhesive fluid seal comprises an adhesive medium disposed within the wire passage, and whereby the electrical connector is sealed within the wire passage by the adhesive medium.

4. The refrigerator appliance of claim 1, wherein the water filtration assembly further comprises a filtration medium disposed within the filtration housing.

5. The refrigerator appliance of claim 4, wherein the filtration medium comprises a carbon material.

6. The refrigerator appliance of claim 4, wherein the electrical connector is extended between the filtration medium and the power source to electrically couple the filtration medium to the power source.

7. The refrigerator appliance of claim 1, wherein the end cap is overmolded over the electrical connector.

8. The refrigerator appliance of claim 1, wherein the water filtration assembly comprises a first electrode and a second electrode, wherein the first electrode is operable positioned to a filtration medium disposed within the filtration housing, wherein the second electrode extends into a volume positioned within the filtration housing separate from the first electrode.

9. The refrigerator appliance of claim 1, wherein the first end comprises at least one fluid inlet port and at least one fluid outlet port secured to the manifold for receiving fluid from a fluid source.

10. A water filtration assembly comprising:
a filtration housing forming a first end distal from a second end, the second end defining a cap opening;
an end cap defining a wire passage therethrough, the end cap being mated to the filtration housing at the cap opening, the end cap comprising a circumferential fluid seal, the circumferential fluid seal being attached to the end cap, the circumferential fluid seal being positioned between the end cap and the cap opening to seal the filtration housing; and
an electrical connector extending through the wire passage to electrically connect the filtration housing to a power source separate from the water filtration assembly.

11. The water filtration assembly of claim 10, wherein the end cap comprises a cylindrical body and a neck extended from the cylindrical body, wherein the circumferential fluid seal comprises one or more O-ring seals, and wherein the neck comprises one or more slots for receiving the one or more O-ring seals.

12. The water filtration assembly of claim 10, wherein the end cap further comprises an adhesive fluid seal, wherein the adhesive fluid seal comprises an adhesive medium disposed within the wire passage, and whereby the electrical connector is sealed within the wire passage by the adhesive medium.

13. The water filtration assembly of claim 10, wherein the water filtration assembly further comprises a filtration medium disposed within the filtration housing.

14. The water filtration assembly of claim 13, wherein the filtration medium comprises a carbon material.

15. The water filtration assembly of claim 13, wherein the electrical connector is extended between the filtration medium and the power source to electrically couple the filtration medium to the power source.

16. The water filtration assembly of claim 10, wherein the end cap is overmolded over the electrical connector.

17. The water filtration assembly of claim 10, wherein the water filtration assembly comprises a first electrode and a second electrode, wherein the first electrode is operable positioned to a filtration medium disposed within the filtration housing, wherein the second electrode extends into a volume positioned within the filtration housing separate from the first electrode.

18. The water filtration assembly of claim 10, wherein the first end comprises at least one fluid inlet port and at least one fluid outlet port for receiving fluid from a fluid source.
